(19) United States
(12) Patent Application Publication
(10) Pub. No.: US 2022/0206725 A1
(43) Pub. Date: Jun. 30, 2022

(54) PROGRAMMABLE REDACTION FOR SECURE UI, REPORTS, SCANS, AND PRINTS

(71) Applicant: Xerox Corporation, Norwalk, CT (US)

(72) Inventor: John F. Whiting, Webster, NY (US)

(73) Assignee: Xerox Corporation, Norwalk, CT (US)

(21) Appl. No.: 17/137,456

(22) Filed: Dec. 30, 2020

(51) Int. Cl. G06F 3/12; G06F 21/62; G06F 40/237; H04N 1/00; H04N 1/44

(52) U.S. Cl. CPC G06F 3/1238; G06F 3/1222; H04N 1/444; G06F 40/237; H04N 1/00864; G06F 21/6245

(57) ABSTRACT

An exemplary apparatus includes a processor, a printing device, a user interface, and an input/output device. The printing device is in communication with the processor. The user interface is in communication with the processor. The input/output device is in communication with the processor and with a computerized network external to the apparatus. The processor is adapted to maintain a general lexicon of mask words. The processor is adapted to provide, through the user interface and the computerized network, options to change the mask words in the general lexicon to create a local lexicon. The processor is adapted to redact the mask words in the local lexicon from at least one of: printed items; items displayed on the user interface; and items provided to the computerized network through the input/output device.

### BACKGROUND

Devices and methods herein generally relate to machines having print engines such as printers and/or copier devices and, more particularly, to devices and methods for controlling production and reproduction of documents containing sensitive information by automatic redaction using an account-administered lexicon of sensitive words/phrases and personal names.

Individuals are often comfortable dealing with documents in hardcopy format. In general, hardcopy documents are easier to read, handle, and store than documents kept in the digital domain. However, control of document reproduction and dissemination is a concern because copies of documents containing sensitive information can be easily transmitted from person to person. As such, there is a risk of documents containing sensitive information being reproduced innocently or illicitly by persons without authorization.

In an ever-increasing awareness of the need to keep secure data and Person Identifiable Information (PII) away from intentional or unintentional prying eyes, the need to mask/remove certain elements of secure information, such as code names, customer names, personal names, etc., has become a vital reality. Methods exist to limit the usefulness of unauthorized copying of documents. The emergence of electronic document processing systems has enhanced significantly the functional utility of plain paper and other types of hardcopy documents. Current approaches to dealing with security of electronic document processing systems are heavily human-centered, requiring users to be careful what terms and names they expose as they print, scan, and/or copy documents, as well as limiting exposing secure items in job queues and reports.

While some drivers allow for masking job names or personal names and some printers can be set up to mask/delete all job names or personal names, the effectiveness of current approaches is based on the user setting it up, remembering to use it, and having the masks carry over into usage reports, etc. Additionally, in long job queues, just masking the entire job name for several jobs leads to end users not being able to tell which job is which.

In another approach, human readable information on a document is supplemented by writing appropriate machine readable digital data on the document to control selective exposure of sensitive information. The machine readable digital data enables the hardcopy document to actively interact with certain document processing systems when the document is scanned into the system by an ordinary input scanner.

However, prior attempts to control reproduction offer access that is all or nothing. Once access is granted, it cannot be controlled in any other way. This makes it difficult to control who should have access to the information contained within the document. Prior attempts are limited in that once access is granted, the entire document is decoded. More to the point, the images the user prints, scans, or copies may be filled with sensitive terms or PII, which can be recopied, re-emailed, and/or re-scanned ad infinitum. These terms or PII may even be protected by law and come with significant penalties for unauthorized exposure.

A need exists for a device and method that controls the production and reproduction of sensitive information and PII by restrictions associated with policies incorporated in an account-administered lexicon of sensitive words/phrases and personal names.

### SUMMARY

According to devices and methods herein, a document output device, such as a Multi-Function Device (MFD), can be set up to redact or mask text or names that represent sensitive information. By using a lexicon or directory, an administrator of the device can configure the device to protect certain data that may be printed, displayed at a User Interface (UI), or transmitted off the device. A general lexicon of mask words can be established according to policy guidelines. At an output device, the mask words in the general lexicon can be changed to create a local lexicon. Devices and methods herein help to avoid user error by setting up the device to automatically detect the sensitive data and redact it or substitute non-sensitive text. The methodology can be extended to allow personal configuration settings and policies to protect additional text and names using a modified local lexicon.

In operation, corporate policies can be established to protect disclosure of sensitive information and names, whether such disclosure is inadvertent or willful. A general lexicon, directory, or database of words, phrases, titles, names, can be setup by an administrator, so that each user does not even need to be aware of corporate policies. The administrator can also change the mask words in the general lexicon at an output device to create a local lexicon for use by specific output devices or specific users.

According to an exemplary apparatus herein, the apparatus includes a processor, a printing device, a user interface, and an input/output device. The printing device is in communication with the processor. The user interface is in communication with the processor. The input/output device is in communication with the processor and with a computerized network external to the apparatus. The processor is adapted to maintain a general lexicon containing mask words. The processor is adapted to provide, through the user interface and the computerized network, options to change the mask words in the general lexicon to create a local lexicon. The processor is adapted to redact the mask words in the local lexicon from at least one of: printed items; items displayed on the user interface; systems that report on device usage; and items provided to the computerized network through the input/output device.

An exemplary printing device herein includes an input device receiving a job for printing or scanning. The job includes a document that may be an electronic document. A processor is operatively connected to the input device. A user interface is operatively connected to the processor. A data transfer device is in communication with the processor and with a computerized network external to the printing device. A marking device is operatively connected to the processor. The processor is adapted to maintain a general lexicon containing mask words. The processor is adapted to provide, through the user interface and the computerized network, options to change the mask words in the general lexicon to create a local lexicon. The processor is adapted to redact the mask words in the local lexicon from the document to create a modified document. The marking device is adapted to print the modified document. The data transfer device is adapted to send the modified document to a storage device or another network connected device. The storage device is adapted to store the modified document.

According to an exemplary method herein, a job is received into a computerized device. The job includes an electronic document. A selection for a general lexicon containing mask words, which is maintained by a processor of the computerized device, is displayed on a user interface of the computerized device. Input is received into the user interface to define a local lexicon from the general lexicon of mask words. The local lexicon is created by changing the mask words in the general lexicon of mask words. The local lexicon is used to redact words from the electronic document to create a modified document. The modified document is output from the computerized device.

These and other features are described in, or are apparent from, the following detailed description.

### BRIEF DESCRIPTION OF THE DRAWINGS

Various examples of the devices and methods are described in detail below, with reference to the attached drawing figures, which are not necessarily drawn to scale and in which:

FIG. 1 shows a flow diagram according to devices and methods herein;

FIG. 2 shows flow diagrams illustrating redaction for copy, scan, and print processes according to devices and methods herein;

FIG. 3 shows flow diagrams illustrating redaction for job queues and report processes according to devices and methods herein;

FIG. 4 is a block diagram of a network according to devices and methods herein;

FIG. 5 is a schematic diagram illustrating devices herein;

FIG. 6 is a schematic diagram illustrating devices herein;

FIG. 7 is a schematic diagram illustrating devices and methods herein;

FIGS. 8A-8C show illustrations of User Interface displays for performing processes according to devices and methods herein;

FIG. 9 shows illustrations of User Interface displays for performing processes according to devices and methods herein; and

FIG. 10 is a flow chart illustrating methods herein.

### DETAILED DESCRIPTION

For a general understanding of the features of the disclosure, reference is made to the drawings. In the drawings, like reference numerals have been used throughout to identify identical elements. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

As used herein, an image forming device can include any device for rendering an image on print media, such as a copier, laser printer, bookmaking machine, facsimile machine, or a multifunction machine (which includes one or more functions such as scanning, printing, archiving, emailing, and faxing). “Print media” can be a physical sheet of paper, plastic, or other suitable physical print media substrate for carrying images. A “job”, “print job”, or “document” is referred to for one or multiple sheets copied from an original print job sheet(s) or an electronic document page image, from a particular user, or otherwise related. An original image is used herein to mean an electronic (e.g., digital) or physical (e.g., paper) recording of information. In its electronic form, the original image may include image data in a form of text, graphics, or bitmaps.

As would be known by one skilled in the art, a raster image processor is a component used in a printing system that produces a raster image, also known as a bitmap. The bitmap is then sent to a printing device for output. Raster image processing is the process that turns the job input information into a high-resolution raster image. The input may be a page description using a page description language (PDL) of higher or lower resolution than the output device. In the latter case, the RIP applies either smoothing or interpolation to the input bitmap to generate the output bitmap.

To print an image, a print engine processor, sometimes referred to herein as an image processor, converts the image in a page description language or vector graphics format to a bit mapped image indicating a value to print at each pixel of the image. Each pixel may represent a dot, also called a picture element. The sequence of dots forming a character is called a raster pattern. The number of dots per inch that a printer generates is called the print resolution, or density. A resolution of 240 pixels means that a printer prints 240 pixels per inch both vertically and horizontally, or 57,306 pixels per square inch (240×240).

As used herein, a “pixel” refers to the smallest segment into which an image can be divided. Each bit representing a pixel that is “on” is converted to an electronic pulse. The electronic pulses generated from the raster pixel data at which to deposit toner turns the laser beam on to positively charge the surface of a rotating drum, which is an organic photo-conducting cartridge (OPC) that has a coating capable of holding an electrostatic charge. The laser beam turns on and off to beam charges at pixel areas on a scan line across the drum that will ultimately represent the output image. After the laser beam charges all pixels on the scan line indicated in the raster data, the drum rotates so the laser beam can place charges on the next scan line. The drum with the electrostatic positive charges then passes over negatively charged toner. The negatively charged toner is then attracted to the positive charged areas of the drum that form the image. The paper, which is negatively charged, passes over the roller drum and attracts the toner as the areas of the roller drum with the toner are positively charged to transfer the toner forming the image from the roller drum to the paper.

Thus, an input device is any device capable of obtaining pixel values from an image. The set of image input devices is intended to encompass a wide variety of devices such as, for example, digital document devices, computer systems, memory and storage devices, networked platforms such as servers and client devices which can obtain pixel values from a source device. An image output device is any device capable of rendering the image. The set of image output devices includes digital document reproduction equipment and other copier systems as are widely known in commerce, photographic production and reproduction equipment, monitors and other displays, computer workstations and servers, including a wide variety of marking and image-sending or storage devices, and the like. To render an image is to reduce the image data (or a signal thereof) to viewable form; store the image data to memory or a storage device for subsequent retrieval; or communicate the image data to another device. Such communication may take the form of transmitting a digital signal of the image data over a network.

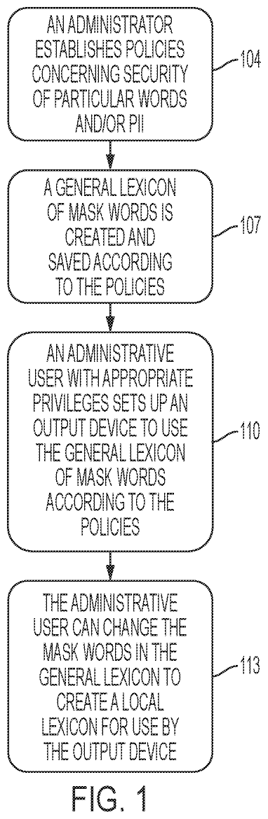

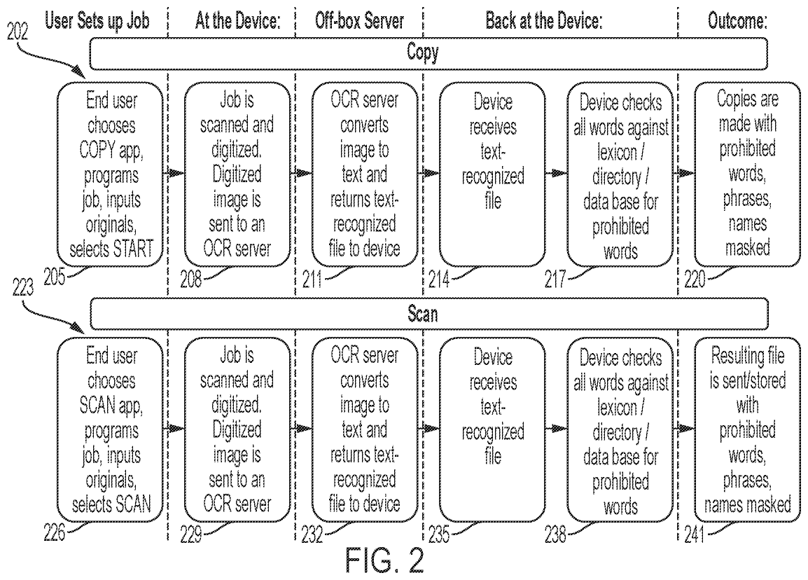

Referring now to the drawings, FIG. 1 shows a flow diagram for establishing a general lexicon of mask words that can be used to redact sensitive terms or person identifiable information (PII). At 104, an administrator establishes policies concerning security of particular words and/or PII. At 107, a general lexicon of mask words is created and saved according to the policies. At 110, an administrative user having appropriate privileges sets up an output device to use the general lexicon of mask words according to the policies. At 113, the administrative user can change the mask words in the general lexicon to create a local lexicon for use by the output device. The administrative user can establish the local lexicon to enable personalization to allow end users to protect their name and information. In this way, the output device can become an integral player in an overall security regimen by preventing chosen words, phrases, and personal names from being displayed on the local or networked user interfaces, reports, or digital or printed output. Typically, administrators know best which words, phrases, personal names, etc. are most vulnerable to security threats and devices and methods herein gives them full control of which queues, apps, reports, etc. will be protected from human error or malicious spying. It is contemplated that the administrative user can define a first local lexicon for a first end user and a different second local lexicon for a second end user.

The administrative user can set up, by policy, to identify and mask recognizable series of letters or numbers (e.g., Social Security Number sequences (3-digits-2 digits-4 digits)). Such known sequences could be recognized and automatically masked in scans/prints/held jobs. In some cases, the masking process could be set up to print only the last 4 digits and mask the rest.

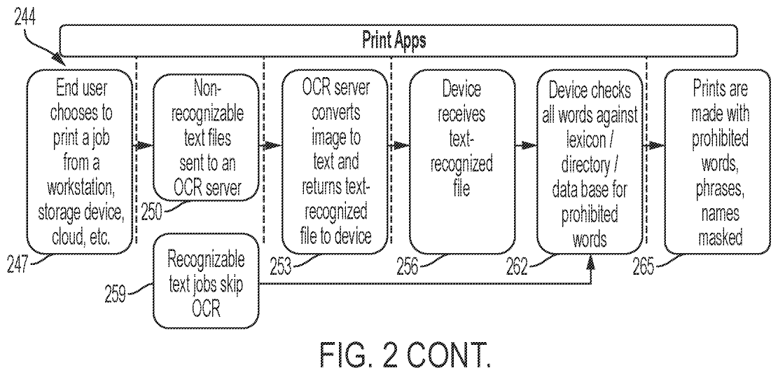

FIG. 2 shows a first flow diagram, indicated generally as 202, for an automatic redaction process incorporated in a copy process. After the administrative user has set up the output device, as described above, an end user chooses a COPY application on the output device, at 205. The end user can program the copy job, input an original document, and press START on a user interface of the output device. At 208, the output device scans the original document and creates a digitized image of the original document, as is known by one of ordinary skill in the art. The digitized image is sent to an OCR server or other appropriate device for character recognition in the digitized image. Optical character recognition is well known in the art. At 211, the OCR server or other appropriate device converts the digitized image to text and returns a text-recognized file to the output device. At 214, the output device receives the text-recognized file and, at 217, the output device checks all the words in the text-recognized file against the lexicon for prohibited words or PII. At 220, the output device processes the copy job and produces copies of the original document with the prohibited words, phrases, names, and/or other person identifiable information masked.

FIG. 2 also shows a second flow diagram, indicated generally as 223, for an automatic redaction process incorporated in a scan process. After the administrative user has set up the output device, as described above, an end user chooses a SCAN application on the output device, at 226. The end user can program the scan job, input an original document, and press SCAN on a user interface of the output device. At 229, the output device scans the original document and creates a digitized image of the original document, as is known by one of ordinary skill in the art. The digitized image is sent to an OCR server or other appropriate device for character recognition in the digitized image. Optical character recognition is well known in the art. At 232, the OCR server or other appropriate device converts the digitized image to text and returns a text-recognized file to the output device. At 235, the output device receives the text-recognized file and, at 238, the output device checks all the words in the text-recognized file against the lexicon for prohibited words or PII. At 241, the output device processes the scan job and produces a file with the prohibited words, phrases, names, and/or other person identifiable information masked. The file can be sent or stored as selected by the end user.

Still referring to FIG. 2, which shows a third flow diagram, indicated generally as 244, for an automatic redaction process incorporated in a printing process. Again, after the administrative user has set up the output device, as described above, an end user chooses the output device to be used as a printer, at 247. The print job can come from a workstation, a storage device, a network location, etc. At 250, non-recognizable text files are sent to an OCR server or other appropriate device for character recognition. Optical character recognition is well known in the art. At 253, the OCR server or other appropriate device converts the image to text and returns a text-recognized file to the output device. At 256, the output device receives the text-recognized file. As noted at 259, recognizable text jobs can skip the OCR process. At 262, the output device checks all the words in the text-recognized file against the lexicon for prohibited words or PII. At 265, the output device makes prints with the prohibited words, phrases, names, and/or other person identifiable information masked.

In other words, a user with administrative privileges sets up the output device according to policies, such as that all personal names, text being printed or scanned (through text recognition) are checked against an account-administered lexicon of sensitive words/phrases and personal names. If sensitive text/phrases or personal names that are listed in the lexicon/directory are contained in a copy, scan, or print job, then those words/phrases and personal names are automatically rendered unreadable via masking or blanking on copied, scanned, or printed output if designed to do so and set up by policy.

Similarly, devices and methods herein can be used to render personal names and text unreadable before a report is generated and before such information is displayed on the local or web user interfaces for the output device. Devices and methods herein could allow an end user to delete Personal Name or File Name or a record from the Web UI and/or device logs at the same time. Further, devices and methods herein can be used to prevent selected personal names or text from being shared via bi-directional communication with client devices or other communication channels.

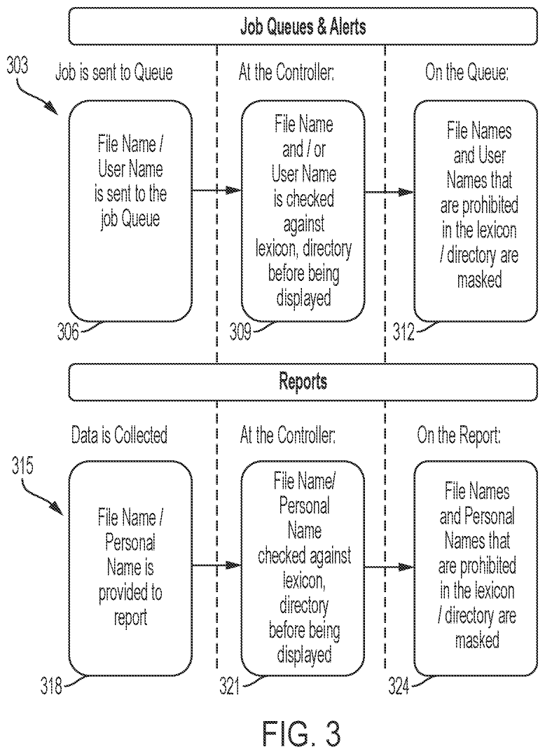

Referring now to FIG. 3, which shows a first flow diagram, indicated generally as 303, for an automatic redaction process to render personal names and file names unreadable in a job queue. After the administrative user has set up the output device, as described above, at 306, an end user sends a job to a job queue. At 309, a controller for the job queue checks all the words in the file name and/or the end user name against the lexicon for prohibited words or PII. At 312, the prohibited words, phrases, names, and/or other person identifiable information are masked.

FIG. 3 also shows a second flow diagram, indicated generally as 315, for an automatic redaction process to render personal names and file names unreadable in a report. After the administrative user has set up the output device, as described above, at 318, file names and/or personal names are provided to a report. At 321, a controller checks all the words in the file name and/or the end user name against the lexicon for prohibited words or PII. At 324, the prohibited words, phrases, names, and/or other person identifiable information are masked on the report.

According to devices and methods herein, the masking process could be set up to replace redacted words or names with a more generic or less security-sensitive word or name. For example, in a document that uses the proper name of a corporate executive, instead of masking it (****), the processor inserts, for example “Corporate CEO”. In a similar fashion, the same functionality could be used to update all data transmissions when a universal change is implemented. (e.g., Company A is bought out by Company X). Devices and methods herein could be used to always automatically change the old Company A name to ‘Company X’ in all copies, prints and scans going through an output device.

In some cases, the administrative user could set up policies based on level of clearance. This could be useful for ‘group’ mail, distribution lists, etc. For example, scans sent to lower clearance addresses could contain redactions that higher-level clearance recipients are not subject to.

In some cases, the administrative user can schedule removal of words and names in the lexicon and directory; for example, the device can be set up to remove all personal names and job names that match entries in the lexicon and directory from the device queues and reports at the end of each business day. A feature can be added, such as “Clear my info”, so that before an end user walks away from the output device (either by policy or a user selection of a button on a clear all or logout confirmation screen) PII is removed or deleted. In some cases, the end user can be queried if he/she wants to remove the record of their session upon logging out. Such feature can be combined with personalization to allow end users to protect their name and information.

According to devices and methods herein, a policy could be set up based on time of day or day of week. For example, held jobs printed after a certain time (e.g., 5 pm) must redact sensitive word and personal names.

Using similar methodology, a user with administrative privileges could sets up a device to prevent selected personal names or text from being shared via bi-directional communication with client devices or other communication channels, according to appropriate policies. Indeed, policies can allow a device to automatically populate the directory from LDAP (Lightweight Directory Access Protocol), which is an open and cross platform protocol used for directory services authentication, as would be know by one of ordinary skill in the art.

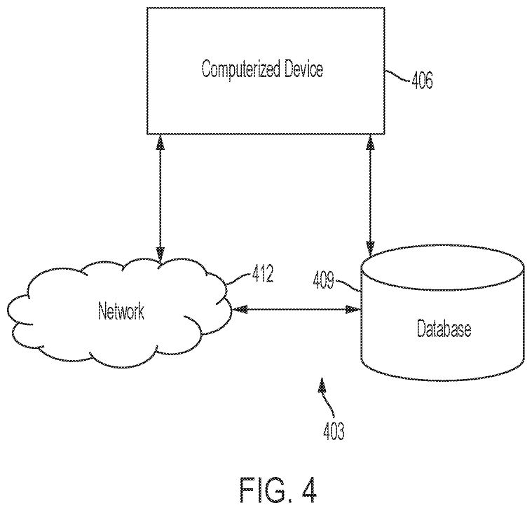

FIG. 4 is a general overview block diagram of a network, indicated generally as 403, for communication between a computerized device 406 and a database 409. The computerized device 406 may comprise any form of processor as described in detail herein. The computerized device 406 can be programmed with appropriate application software to implement the methods described herein. Alternatively, the computerized device 406 may be a special purpose machine that is specialized for processing image data and includes a dedicated processor that would not operate like a general purpose processor because the dedicated processor has application specific integrated circuits (ASICs) that are specialized for the handling of image processing operations, processing pixel data, etc. In one example, the computerized device 406 is special purpose machine that includes a specialized card having unique ASICs for providing image processing instructions, includes specialized boards having unique ASICs for input and output devices to speed network communications processing, a specialized ASIC processor that performs the logic of the methods described herein using dedicated unique hardware logic circuits, etc.

Database 409 includes any database or any set of records or data that the computerized device 406 desires to retrieve. Database 409 may be any organized collection of data operating with any type of database management system. The database 409 may contain matrices of datasets comprising multi-relational data elements. According to devices and methods herein, the database 409 may contain a lexicon of sensitive words/phrases and personal names.

The database 409 may communicate with the computerized device 406 directly. Alternatively, the database 409 may communicate with the computerized device 406 over network 412. The network 412 comprises a communication network either internal or external, for affecting communication between the computerized device 406 and the database 409.

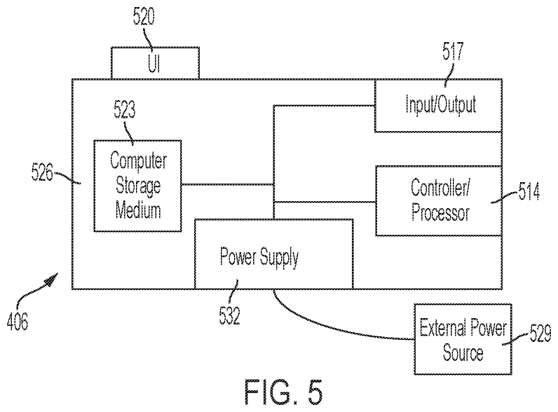

FIG. 5 illustrates a computerized device 406 in more detail. Computerized device 406 can be used with devices and methods herein and can comprise, for example, a print server, a personal computer, a portable computing device, etc. The computerized device 406 includes a processor 514 (sometimes referred to as a controller/processor) and a communications port (Input/Output device 517) operatively connected to the processor 514 and to the computerized network 412 external to the computerized device 406. Also, the computerized device 406 can include at least one accessory functional component, such as a user interface (UI) 520, sometimes referred to as a control panel. The user may receive messages, instructions, and menu options from, and enter instructions through, the user interface 520 (control panel).

The input/output device 517 may include a data transfer device and is used for communications to and from the computerized device 406. The input/output device 517 may comprise a wired device or wireless device (of any form, whether currently known or developed in the future). The processor 514 controls the various actions of the computerized device. A non-transitory, tangible, computer storage medium device 523 (which can be optical, magnetic, capacitor based, etc., and is different from a transitory signal) is readable by the processor 514 and stores instructions that the processor 514 executes to allow the computerized device to perform its various functions, such as those described herein. For example, according to devices and methods herein, the processor 514 may be adapted to maintain a general lexicon of mask words. Further, the processor 514 may be adapted to provide, through the user interface 520, options to change the mask words in the general lexicon to create a local lexicon.

Thus, as shown in FIG. 5, a body housing 526 has one or more functional components that operate on power supplied from an external power source 529, such as an alternating current (AC) source, by the power supply 532. The power supply 532 can comprise a common power conversion unit, power storage element (e.g., a battery, etc.), etc.

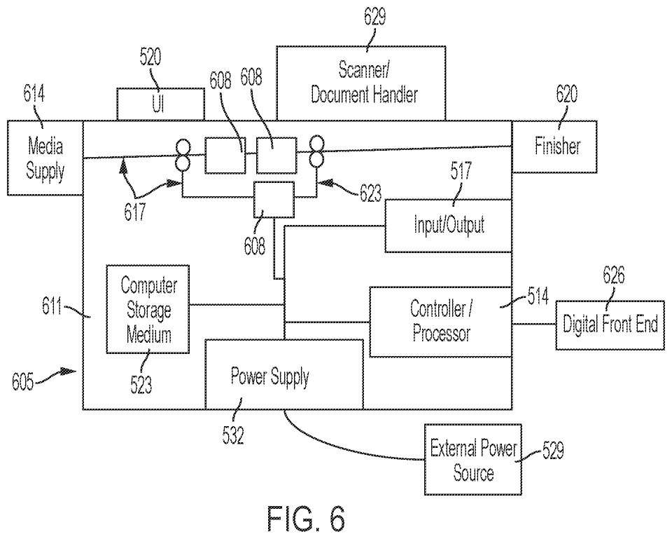

FIG. 6 illustrates a computerized device that is a multi-function device (MFD) 605, which can be used with devices and methods herein and can comprise, for example, a printer, copier, multi-function machine, etc. The MFD 605 includes a controller/processor 514 and at least one marking device (print engine(s)) 608 operatively connected to the controller/processor 514. The MFD 605 may also include a communications port (Input/Output device 517) operatively connected to the controller/processor 514 and to the computerized network 412 external to the MFD 605. The input/output device 517 may be used for communications to and from the MFD 605 to send an image to another network connected device or to storage.

The controller/processor 514 controls the various actions of the MFD 605, as described below. A non-transitory computer storage medium device 523 (which can be optical, magnetic, capacitor based, etc.) is readable by the controller/processor 514 and stores instructions that the controller/processor 514 executes to allow the MFD 605 to perform its various functions, such as those described herein.

According to devices and methods herein, the controller/processor 514 may comprise a special purpose processor that is specialized for processing image data and includes a dedicated processor that would not operate like a general purpose processor because the dedicated processor has application specific integrated circuits (ASICs) that are specialized for the handling of image processing operations, processing image data, calculating pixel values, etc. In one example, the MFD 605 is special purpose machine that includes a specialized image processing card having unique ASICs for providing image processing, includes specialized boards having unique ASICs for input and output devices to speed network communications processing, a specialized ASIC processor that performs the logic of the methods described herein using dedicated unique hardware logic circuits, etc. It is contemplated that the controller/processor 514 may comprise a raster image processor (RIP). A raster image processer uses the original image description to RIP the print job. Accordingly, the print instruction data is converted to a printer-readable language. The print job description is generally used to generate a ready-to-print file. The ready-to-print file may be a compressed file that can be repeatedly accessed for multiple (and subsequent) passes.

Thus, as shown in FIG. 6, a body housing 611 has one or more functional components that operate on power supplied from an external power source 529, which may comprise an alternating current (AC) power source, through the power supply 532. The power supply 532 can comprise a power storage element (e.g., a battery) and connects to the external power source 529. The power supply 532 converts the power from the external power source 529 into the type of power needed by the various components of the MFD 605.

The MFD 605 herein has a media supply 614 supplying media to a media path 617. The media path 617 can comprise any combination of belts, rollers, nips, drive wheels, vacuum devices, air devices, etc. The print engine(s) 608 is positioned along the media path 617. That is, the multi-function device 605 comprises a document-processing device having the print engine(s) 608. The print engine(s) 608 prints marks on the media. After receiving various markings from the print engine(s) 608, the sheets of media can optionally pass to a finisher 620 which can fold, staple, sort, etc., the various printed sheets. As described herein, a return paper path 623 may deliver the printed sheets to the same or different print engine 608 for at least a second layer of toner/ink to be applied. Each return of the media to the print engine 608 is referred to herein as a “pass”.

The print engine(s) 608 may be any device capable of rendering the image. The set of marking devices includes, but is not limited to, digital document reproduction equipment and other copier systems, as are widely known in commerce, photographic production and reproduction equipment, monitors and other displays, computer workstations and servers, including a wide variety of marking devices, and the like. That is, the one or more print engines 608 are intended to illustrate any marking device that applies a marking material (toner, inks, etc.) to continuous media or sheets of media, whether currently known or developed in the future and can include, for example, devices that use a photoreceptor belt or an intermediate transfer belt, or devices that print directly to print media (e.g., inkjet printers, ribbon-based contact printers, etc.).

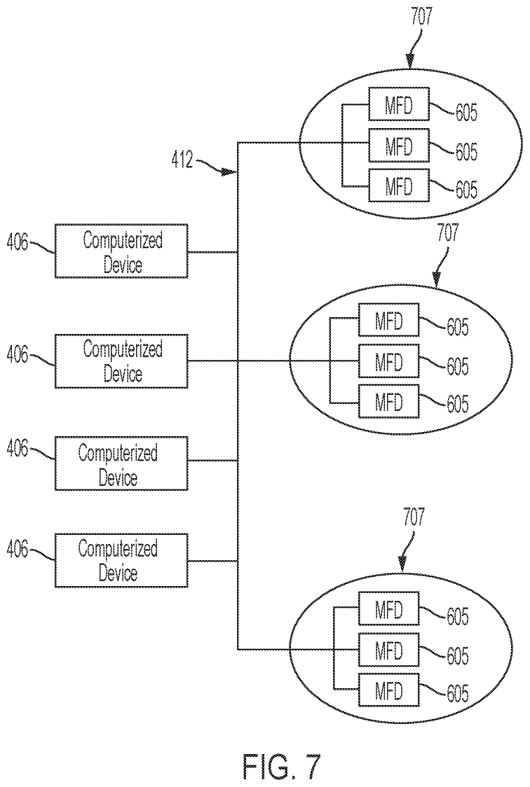

A Digital Front End (DFE) 626 may be connected to the processor 514 of the MFD 605. The DFE 626 prepares and processes a job for the print engine(s) 608 and may include one or more RIPs (raster image processors) that render from a page description language (PDL) such as PostScript, PDF or XPS to a raster: a pixel-based representation of the page suitable for delivery to the print heads of the print engine(s) 608. The DFE 626 is able to load files from various sources on a network, such as shown in FIG. 7, and process them in order to be printed on digital equipment, whether it be a small desktop printer or a large digital press. The processor 514 takes the imposed print ready input from the DFE 626 and controls the print engine(s) 608 for printing.

In addition, the MFD 605 can include at least one accessory functional component, such as a scanner/document handler 629, automatic document feeder (ADF), etc. that operate on the power supplied from the external power source 529 (through the power supply 532). The scanner/document handler 629 is adapted to scan pages for copying or entering into a file. The processor 514 is adapted to automatically redact mask words in the local or general lexicon from at least one of: printed items; items displayed on the user interface 520; and items provided to the networks through the input/output device 517.

In other words, the Multi-Function Device (MFD) 605 can print, send, and store images. That is, the MFD 605 can perform printing from the scanner (e.g., copying), from a client, from a storage device (e.g., attached via a USB cable or flash drive), from a smart phone (e.g., through Bluetooth) and even from the user's access card. The MFD 6058 can also send data to other places electronically via phone lines (e.g., Fax), email, directly to clients or other multi-function devices (e.g., Network Scanning), other servers, and to storage (e.g., Cloud storage, mainframes, etc.). Additionally the MFD 605 is often equipped with its own storage capability, in addition to the non-transitory computer storage medium device 523. According to devices and methods herein, the MFD 605 can enable automatic redaction of mask words in the lexicon on all functions and communications from the MFD 605.

As would be understood by those ordinarily skilled in the art, the multi-function device 605 shown in FIG. 6 is only one example and the devices and methods herein are equally applicable to other types of devices that may include fewer components or more components. For example, while a limited number of print engines and media paths are illustrated in FIG. 6, those ordinarily skilled in the art would understand that many more paper paths and additional print engines could be included within any device used with embodiments herein.

As shown in FIG. 7, exemplary printers, copiers, multi-function machines, and multi-function devices (MFD) 605 may be located at various different physical locations 707. Other devices according to devices and methods herein may include various computerized devices 406. The computerized devices 406 can include print servers, printing devices, personal computers, etc., and are in communication (operatively connected to one another) by way of the network 412. The network 412 may be any type of network, including a local area network (LAN), a wide area network (WAN), or a global computer network, such as the Internet.

The processing described herein can be performed by one machine individually or by a combination of machines acting together. For example, the MFDs 605 can individually perform all functions described above in a stand-alone manner. Alternatively, the processing described above as being performed by the processor and some of the user interface display operations can be performed by various ones of the computerized devices 406, with the scanning process being performed by the MFDs 605 or stand-alone scanners.

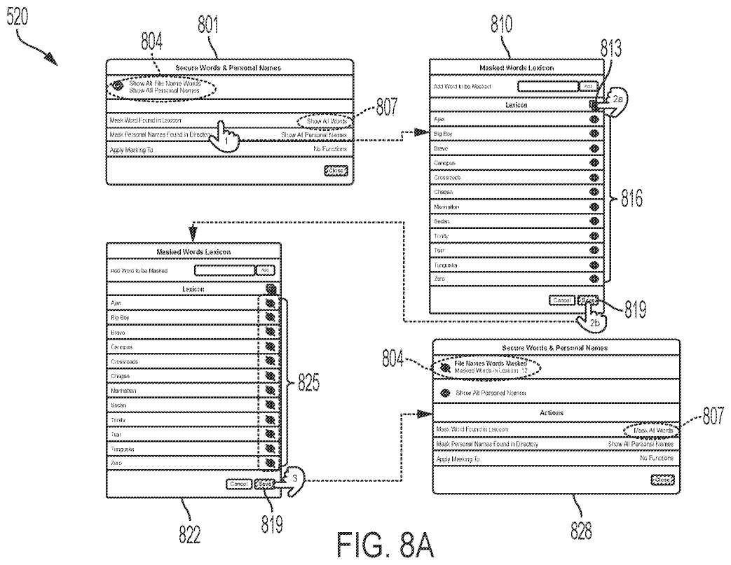

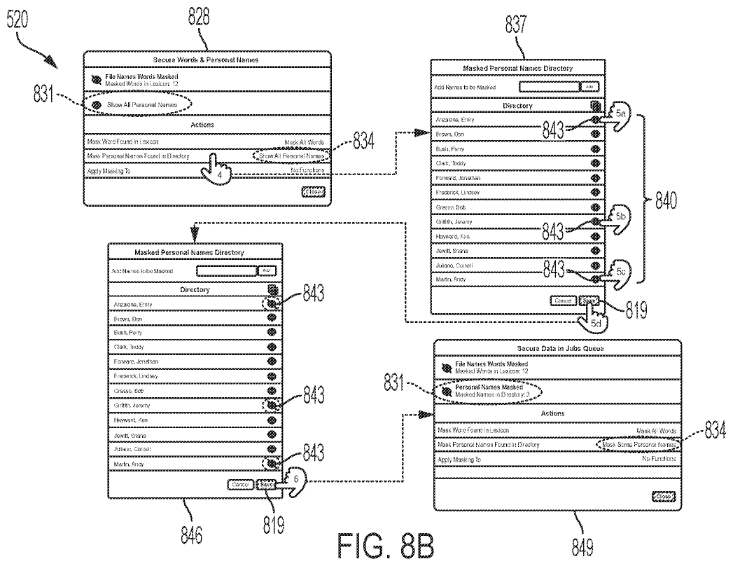

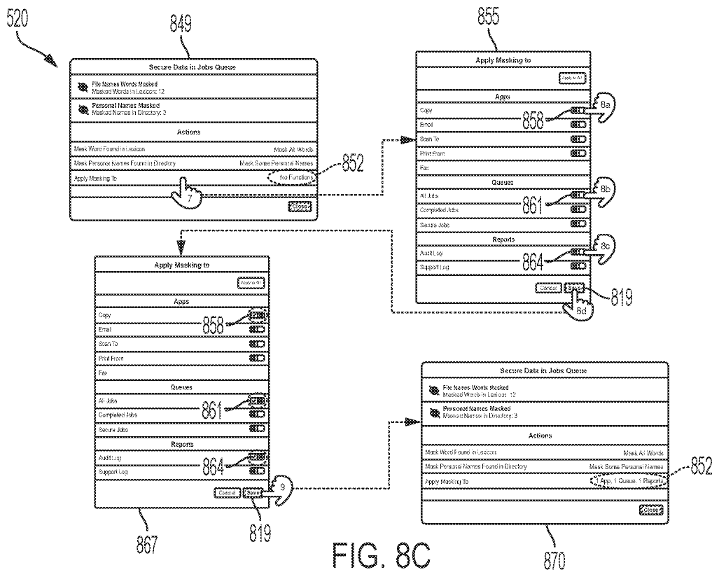

Referring now to FIGS. 8A-8C, a general lexicon, directory, or database of words, phrases, titles, names, can be setup by an administrator. The administrator can also change the mask words in the general lexicon at an output device to create a local lexicon for use by specific output devices. In some cases, the user interface 520 may include a touch-sensitive screen or that is controlled by other forms of user input (such as a pointer-based device/mouse, etc.) by which a user can interact with the processor 514. Applicant notes that such user interface screens are well known in the art. FIGS. 8A-8C illustrate exemplary views of displays on the user interface 520 for setting up and modifying a general lexicon and applying the selected masking according to devices and methods herein. More specifically, referring to FIG. 8A, the user interface 520 may initially show the display 801, which shows the status at 804 ‘Show All File Name Words’ and ‘Show All Personal Names’ (i.e., not masked). The current status of Mask Words Found in Lexicon is also shown in this display at 807—‘Show All Words’. Using display 801, an administrative user can touch the screen, as indicated by 1. This can change the image on the user interface 520 to show the Masked Words Lexicon on display 810. Then, using display 810, the administrative user can touch a radio button 813 to toggle on or off whether a word can be displayed. In display 810, the ‘eye’ for each word is ‘on’, such as indicated at 816. Using the radio button 813, the administrative user can turn off the words, as indicated by 2a. Then, touching the ‘Save’ button 819, as indicated by 2b, changes to display 822, which shows the ‘eye’ for each word is ‘off’, such as indicated at 825. Touching the ‘Save’ button 819 again, as indicated by 3, changes to display 828, which shows the status at 804 of ‘File Name Words Masked’ and at 807, ‘Mask All Words’.

Now referring to FIG. 8B, the user interface 520 shows display 828, which shows the status at 831 ‘Show All Personal Names’ (i.e., not masked). The current status of mask words is also shown in this display at 834—‘Show All Personal Names’. Using display 828, an administrative user can touch the screen, as indicated by 4. This can change the image on the user interface 520 to show the Masked Personal Names Directory on display 837. In display 837, the ‘eye’ for each name is ‘on’, such as indicated at 840. Then, using display 837, the administrative user can touch the screen to toggle on or off whether a name can be displayed. In this example, the administrative user has selected three names 843, as indicated by 5a, 5b, 5c. Then, touching the ‘Save’ button 819, as indicated by 5d, changes to display 846, which shows the ‘eye’ for the selected three names 843 is ‘off’. Touching the ‘Save’ button 819 again, as indicated by 6, changes to display 849, which shows the status at 831 of ‘Personal Names Masked’ and at 834, ‘Mask Some Personal Names’.

FIG. 8C shows exemplary views of displays on the user interface 520 for selectively applying the masking according to devices and methods herein. After selecting the mask words and personal names, display 849, shows that no functions have the mask applied, as shown at 852—‘No Functions’. Using display 849, an administrative user can touch the screen, as indicated by 7. This can change the image on the user interface 520 to show display 855 to ‘Apply Masking To’. In display 855, toggle buttons for each of Applications, Queues, and Reports can be provided separately. Using display 855, the administrative user can touch the screen to toggle on or off whether the mask should be applied to selected functions. In this example, the administrative user has selected the ‘Copy’ function 858, as indicated by 8a, ‘All Jobs’ in the queue 861, as indicated by 8b, and the ‘Audit Log’ report 864, as indicated by 8c. Then, touching the ‘Save’ button 819, as indicated by 8d, changes to display 867, which shows the ‘switch’ for the selected functions 858, 861, 864 is ‘on’, which means the mask will be applied to the selected functions. Touching the ‘Save’ button 819 again, as indicated by 9, changes to display 870, which shows the status at 852 that, in this example, the mask is applied to 1 App, 1 Queue, and 1 Report. As would be understood by one of ordinary skill in the art, the selected masking can be applied to additional applications, queues, and/or reports.

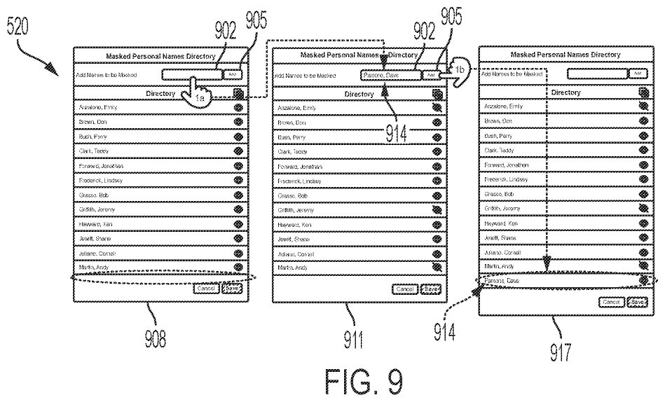

FIG. 9 illustrates exemplary views of displays on the user interface 520 for adding or removing names to the lexicon or directory according to devices and methods herein. The user interface 520 can provide field(s) 902 to input data and button(s) 905 for selected actions. The user can interact with the processor 514 by operation of the button 905 and/or entry of data into the field 902. More specifically, the user interface 520 may initially show the display 908. The user can add a name to be masked into the field 902, indicated by 1a. On display 911 of the user interface 520, the user can press button 905, indicated by 1b. In display 911 the button 905 is designated as an ‘Add’ button. The user interface 520 then shows that the new name 914 is in the lexicon, as shown in display 917.

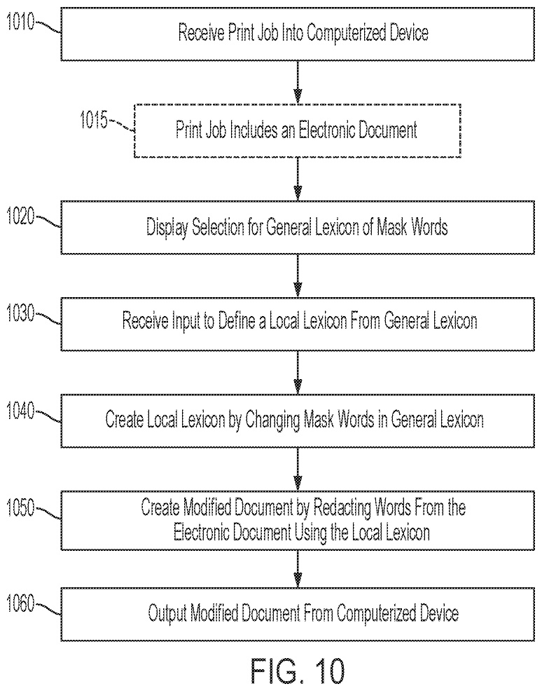

FIG. 10 is a flow diagram illustrating the processing flow for programmable redaction for secure user interfaces, reports, scans, and prints, such as described above. At 1010, a job is received into a computerized device. The job includes an electronic document, as indicated at 1015. At 1020, selection for a general lexicon containing mask words maintained by a processor of the computerized device is displayed on a user interface of the computerized device. Input is received into the user interface, at 1030, to define a local lexicon from the general lexicon of mask words. At 1040, the local lexicon is created by changing the mask words in the general lexicon of mask words. At 1050, the local lexicon is used to redact words from the electronic document to create a modified document. At 1060, the modified document is output from the computerized device.

According to a further devices and methods herein, an article of manufacture is provided that includes a tangible computer readable medium having computer readable instructions embodied therein for performing the steps of the computer implemented methods, including, but not limited to, the method illustrated in FIG. 10. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination of the foregoing. Any of these devices may have computer readable instructions for carrying out the steps of the methods described above with reference to FIG. 10.

The computer program instructions may be stored in a computer readable medium that can direct a computer, other programmable data processing apparatus, or other devices to process in a particular manner, such that the instructions stored in the computer readable medium produce an article of manufacture including instructions which implement the process/act specified in the flowchart and/or block diagram block or blocks.

The hardware described herein plays a significant part in permitting the foregoing method to be performed, rather than function solely as a mechanism for permitting a solution to be achieved more quickly, (i.e., through the utilization of a computer for performing calculations). Specifically, printers, scanners, and image processors that alter electronic documents each play a significant part in the methods (and the methods cannot be performed without these hardware elements). Therefore, these hardware components are fundamental to the methods being performed and are not merely for the purpose of allowing the same result to be achieved more quickly.

As would be understood by one ordinarily skilled in the art, the processes described herein cannot be performed by human alone (or one operating with a pen and a pad of paper) and instead such processes can only be performed by a machine. Specifically, processes such as printing, scanning, using an image processor, etc., require the utilization of different specialized machines. Therefore, for example, the printing/scanning performed by the user device cannot be performed manually (because it can only be done by printing and scanning machines) and is integral with the processes performed by methods herein. In other words, these various machines are integral with the methods herein because the methods cannot be performed without the machines (and cannot be performed by humans alone).

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.) or an system combining software and hardware aspects that may all generally be referred to herein as a ‘circuit’, ‘module, or ‘system.’ Furthermore, aspects of the present disclosure may take the form of a computer program product embodied in one or more computer readable medium(s) having computer readable program code embodied thereon.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, the claims presented below are not intended to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, processors, etc., are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the devices and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, print engines, etc., are well known, and are not described in detail herein to keep this disclosure focused on the salient features presented. The devices and methods herein can encompass devices and methods that print in color, monochrome, or handle color or monochrome image data. All foregoing devices and methods are specifically applicable to electrostatographic and/or xerographic machines and/or processes.

The terms scanner or scanning device as used herein encompasses any apparatus that captures an image of a document for any purpose. The details of scanners, scanning devices, etc., are well known, and are not described in detail herein to keep this disclosure focused on the salient features presented. The devices and methods herein can encompass devices and methods that scan text or other images in color, monochrome, or handle color or monochrome image data. All foregoing devices and methods are specifically applicable to electrostatographic and/or xerographic machines and/or processes.

The terminology used herein is for the purpose of describing particular examples of the disclosed structures and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘comprises’, ‘comprising’, ‘includes’, and/or ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user) one or more machines perform the process without further input from any user.

The corresponding structures, materials, acts, and equivalents of all means or step plus process elements in the claims below are intended to include any structure, material, or act for performing the process in combination with other claimed elements as specifically claimed. The descriptions of the various devices and methods of the present disclosure have been presented for purposes of illustration, but are not intended to be exhaustive or limited to the devices and methods disclosed. Many modifications and variations will be apparent to those of ordinary skill in the art without departing from the scope and spirit of the described devices and methods. The terminology used herein was chosen to best explain the principles of the devices and methods, the practical application or technical improvement over technologies found in the marketplace, or to enable others of ordinary skill in the art to understand the devices and methods disclosed herein.

It will be appreciated that the above-disclosed and other features and processes, or alternatives thereof, may be desirably combined into many other different systems or applications. Those skilled in the art may subsequently make various presently unforeseen or unanticipated alternatives, modifications, variations, or improvements therein, which are also intended to be encompassed by the following claims. Unless specifically defined in a specific claim itself, steps or components of the devices and methods herein should not be implied or imported from any above example as limitations to any particular order, number, position, size, shape, angle, color, temperature, or material.

1. An apparatus, comprising:
a processor;
a printing device in communication with the processor;
a user interface in communication with the processor; and
an input/output device in communication with the processor and with a computerized network external to the apparatus,
wherein the processor is adapted to maintain a general lexicon established by an administrator according to established policies, said general lexicon containing mask words that can be used to redact sensitive terms or person identifiable information (PII),
wherein the processor is adapted to provide, through the user interface and the computerized network, options for the administrator to change the mask words in the general lexicon to create a local lexicon, in which a first local lexicon is defined for a first end user and a second local lexicon is defined for a second end user,
wherein the processor is adapted to redact the mask words in the first local lexicon from at least one of: printed items, items displayed on the user interface, items sent to storage, and items provided to the computerized network through the input/output device, according to the first local lexicon for the first end user, and
wherein the processor is adapted to redact the mask words in the second local lexicon from at least one of: printed items, items displayed on the user interface, items sent to storage, and items provided to the computerized network through the input/output device, according to the second local lexicon for the second end user.

2. (canceled)

3. The apparatus according to claim 1, wherein the processor is adapted to redact the mask words in the first local lexicon from at least one of: job queues and reports, according to the first local lexicon for the first end user, and
wherein the processor is adapted to redact the mask words in the second local lexicon from at least one of: job queues and reports, according to the second local lexicon for the second end user.

4. The apparatus according to claim 1, wherein the processor is adapted to selectively apply the mask words in the first local lexicon to identified applications for the printing device, according to the first local lexicon for the first end user, and
wherein the processor is adapted to selectively apply the mask words in the second local lexicon to identified applications for the printing device, according to the second local lexicon for the second end user.

5. The apparatus according to claim 1, the printing device further comprising a scanner adapted to scan one or more pages from an original document for copying or entering data from the original document into a file, wherein the original document is a paper document or an electronic document.

6. The apparatus according to claim 5, wherein the processor is adapted to redact the mask words in the first local lexicon for the first end user from the original document, and
wherein the processor is adapted to redact the mask words in the second local lexicon for the second end user from the original document.

7. A printing device, comprising:
an input device receiving an original document, wherein the original document is a paper document or an electronic document;
a processor operatively connected to the input device;
a user interface operatively connected to the processor;
a data transfer device in communication with the processor and with a computerized network external to the printing device; and
a marking device operatively connected to the processor,
wherein the processor is adapted to maintain a general lexicon established by an administrator according to established policies, said general lexicon containing mask words that can be used to redact sensitive terms or person identifiable information (PII),
wherein the processor is adapted to provide, through the user interface and the computerized network, options for the administrator to change the mask words in the general lexicon to create a first local lexicon for a first end user and a second local lexicon for a second end user,
wherein the processor is adapted to automatically redact the mask words from the original document, according to the first local lexicon for the first end user and to automatically redact the mask words from the original document, according to the second local lexicon for the second end user, to create a modified document, and
wherein the marking device is adapted to print the modified document.

8. (canceled)

9. The printing device according to claim 7, wherein the processor is adapted to redact the mask words in the first local lexicon for the first end user and to redact the mask words in the second local lexicon for the second end user from at least one of: printed items, items displayed on the user interface, items sent to storage, and items provided to the computerized network through the data transfer device.

10. (canceled)

11. The printing device according to claim 7, wherein the input device further comprises a scanner adapted to scan one or more pages from the original document,
wherein the data transfer device is adapted to receive the original document as a digital file, and
wherein the processor is adapted to send or store the modified document.

12. The printing device according to claim 11, wherein scanning creates a digitized image of the original document, and
wherein the processor is adapted to perform optical character recognition on the digitized image to create a text file comprising words from the original document.

13. The printing device according to claim 7, wherein the processor is adapted to redact the mask words in the first local lexicon for the first end user and to redact the mask words in the second local lexicon for the second end user from at least one of: job queues and reports.

14. The printing device according to claim 7, wherein the processor is adapted to selectively apply the mask words to identified applications for the printing device.

15. A method, comprising:
receiving a job into a computerized device, the job comprising an original document;
displaying, on a user interface of the computerized device, a selection for a general lexicon of mask words maintained by a processor of the computerized device, the general lexicon being created by an administrator according to established policies to redact sensitive terms or person identifiable information (PII);
receiving input into the user interface to define at least one local lexicon from the general lexicon of mask words;
creating the at least one local lexicon by changing the mask words in the general lexicon of mask words, in which a first local lexicon of mask words is defined for a first end user and a second local lexicon of mask words is defined for a second end user;
redacting words from the original document to create a modified document using the mask words in the first local lexicon for the-first end user and using the mask words in the second local lexicon for the second end user; and
outputting the modified document from the computerized device.

16. (canceled)

17. The method according to claim 15, wherein outputting the modified document from the computerized device comprises printing the modified document.

18. The method according to claim 15, further comprising:
redacting text from at least one of: printed items; items displayed on the user interface; and items provided to networks through an input/output device using the mask words in the first local lexicon for the first end user and using the mask words in the second local lexicon for the second end user.

19. The method according to claim 18, wherein the items provided to networks through an input/output device comprise job queues and reports.

20. The method according to claim 15, further comprising:
selectively applying the mask words to identified applications for the computerized device.
